(19) United States
(12) Patent Application Publication
(10) Pub. No.: US 2024/0378483 A1
(43) Pub. Date: Nov. 14, 2024

(54) SYSTEM AND METHOD FOR IMPROVING MEASUREMENT PERFORMANCE OF CHARACTERIZATION SYSTEMS

(71) Applicant: KLA Corporation, Milpitas, CA (US)

(72) Inventors: Stilian Pandev, Santa Clara, CA (US); Proteek Roy, Milpitas, CA (US)

(21) Appl. No.: 18/195,115

(22) Filed: May 9, 2023

(51) Int. Cl. G06N 20/00

(52) U.S. Cl. CPC G06N 20/00

(57) ABSTRACT

A method for improving measurement performance of characterization systems is disclosed. The method may include training a plurality of machine learning models based on a set of training data, where each machine learning model is capable of generating an uncertainty estimator and a first machine learning model is different from one or more additional machine learning models based on one of a set of hyperparameters or a dataset. The method may further include receiving a plurality of sample measurement datasets from one or more test samples. For each of the plurality of sample measurement datasets, the method may further include applying each trained machine learning model to determine a measurement value and the uncertainty estimator for each trained machine learning model and generating a measurement output based on N trained machine learning models with the lowest uncertainty estimators.

### TECHNICAL FIELD

The present disclosure relates generally to characterization systems, and more particularly, to a system and method for improving measurement performance of characterization systems.

### BACKGROUND

Characterization systems typically characterize (e.g., inspect or measure) a variety of characteristics of a sample. For example, metrology systems often measure a variety of characteristics of a sample. As the size of the samples decreases and the sample density increases, the demands on characterization systems needed to characterize the sample increase. Various techniques have been developed to obtain sample measurement data. The collected measurement data may be analyzed by a number of data fitting and optimization techniques (e.g., algorithms, models, or the like). The measurement performance of such systems often degrades when the measured data is outside of the data distribution used for creating and optimizing the measurement recipe. For example, the measurement recipe is often adjusted based on the data within the data distribution and the same recipe is used during runtime on new data which is outside of the distribution, where the measurement performance of the recipe during runtime is typically poor. There is therefore a need to develop systems and methods to cure the above deficiencies.

### SUMMARY

A characterization system is disclosed, in accordance with one or more embodiments of the present disclosure. In embodiments, the system includes one or more controllers including one or more processors configured to execute a set of program instructions stored in memory. In embodiments, the set of program instructions are configured to cause the one or more processors to train a plurality of machine learning models based on a set of training data including empirical data labeled based on known information or simulated data labeled based on known information. In embodiments, each machine learning model of the plurality of machine learning models is capable of generating an uncertainty estimator. In embodiments, a first machine learning model of the plurality of machine learning models is different from the one or more additional machine learning models based on at least one of a set of hyperparameters or a dataset. In embodiments, the set of program instructions are configured to cause the one or more processors receive a plurality of sample measurement datasets from one or more test samples. In embodiments, for each of the plurality of sample measurement datasets, the set of program instructions are configured to cause the one or more processors to apply each trained machine learning model to determine a measurement value and the uncertainty estimator for each trained machine learning model. In embodiments, for each of the plurality of sample measurement datasets, the set of program instructions are configured to cause the one or more processors to generate a measurement output based on N trained machine learning models with the lowest uncertainty estimators, wherein the N trained machine learning models are a sub-set of the plurality of trained machine learning models.

A characterization system is disclosed, in accordance with one or more embodiments of the present disclosure. In embodiments, the system includes a characterization sub-system. In embodiments, the system includes one or more controllers communicatively coupled to the characterization sub-system and including one or more processors configured to execute a set of program instructions stored in memory. In embodiments, the set of program instructions are configured to cause the one or more processors to train a plurality of machine learning models based on a set of training data including empirical data labeled based on known information or simulated data labeled based on known information. In embodiments, each machine learning model of the plurality of machine learning models is capable of generating an uncertainty estimator. In embodiments, a first machine learning model of the plurality of machine learning models is different from the one or more additional machine learning models based on at least one of a set of hyperparameters or a dataset. In embodiments, the set of program instructions are configured to cause the one or more processors receive a plurality of sample measurement datasets from one or more test samples. In embodiments, for each of the plurality of sample measurement datasets, the set of program instructions are configured to cause the one or more processors to apply each trained machine learning model to determine a measurement value and the uncertainty estimator for each trained machine learning model. In embodiments, for each of the plurality of sample measurement datasets, the set of program instructions are configured to cause the one or more processors to generate a measurement output based on N trained machine learning models with the lowest uncertainty estimators, wherein the N trained machine learning models are a sub-set of the plurality of trained machine learning models.

A method is disclosed, in accordance with one or more embodiments of the present disclosure. In embodiments the method includes training a plurality of machine learning models based on a set of training data including empirical data labeled based on known information or simulated data labeled based on known information. In embodiments, each machine learning model of the plurality of machine learning models is capable of generating an uncertainty estimator. In embodiments, a first machine learning model of the plurality of machine learning models is different from one or more additional machine learning models based on at least one of a set of hyperparameters or a dataset. In embodiments, the method includes receiving a plurality of sample measurement datasets from one or more test samples. In embodiments, for each of the plurality of sample measurement datasets, the method includes applying each trained machine learning model to determine a measurement value and the uncertainty estimator for each trained machine learning model. In embodiments, for each of the plurality of sample measurement datasets, the method includes generating a measurement output based on N trained machine learning models with the lowest uncertainty estimators, wherein the N trained machine learning models are a sub-set of the plurality of trained machine learning models.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures in which:

FIG. 1A is a simplified schematic block diagram of a characterization system, in accordance with one or more embodiments of the present disclosure.

FIG. 1B is a simplified schematic view of a characterization sub-system suitable for optical measurements, in accordance with one or more embodiments of the present disclosure.

FIG. 1C is a simplified schematic view of the characterization sub-system configured as an x-ray sub-system, in accordance with one or more embodiments of the present disclosure.

FIG. 1D is a simplified schematic view of the characterization sub-system configured as a particle beam characterization sub-system, in accordance with one or more embodiments of the present disclosure.

FIG. 2 is a flow diagram depicting a method for improving measurement performance, in accordance with one or more embodiments of the present disclosure.

FIG. 3 is simplified block diagram of a process flow diagram depicting the method for improving measurement performance, in accordance with one or more embodiments of the present disclosure.

FIG. 4 is a plot showing data distribution within the training space and outside the training space.

FIG. 5A is a plot showing the distribution of absolute error from an ensemble of models without using an uncertainty estimator.

FIG. 5B is a plot showing the distribution of absolute error from an ensemble of models where the best model is selected using an uncertainty estimator, in accordance with one or more embodiments of the present disclosure.

FIG. 6 is a bar plot showing the reduction of errors by using the uncertainty estimator to select the best model from the ensemble, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the present disclosure.

Embodiments of the present disclosure are directed to systems and methods for improving measurement performance of characterization systems. In particular, embodiments of the present disclosure are directed to a system and method for improving measurement performance of characterization systems using uncertainty estimators. For example, the system may be configured to train a plurality of machine learning models based on a set of training data, where the plurality of machine learning models are each at least partially different from each other (e.g., trained using different training data or including different model hyperparameters). Further, each machine learning model may be capable of generating an uncertainty estimator such that during runtime, the lowest uncertainty estimator(s) for each trained machine learning model may be used to generate one or more measurement outputs. In this regard, the one or more measurement values associated with the one or more machine learning models having the lowest uncertainty estimators may be used to generate the measurement output.

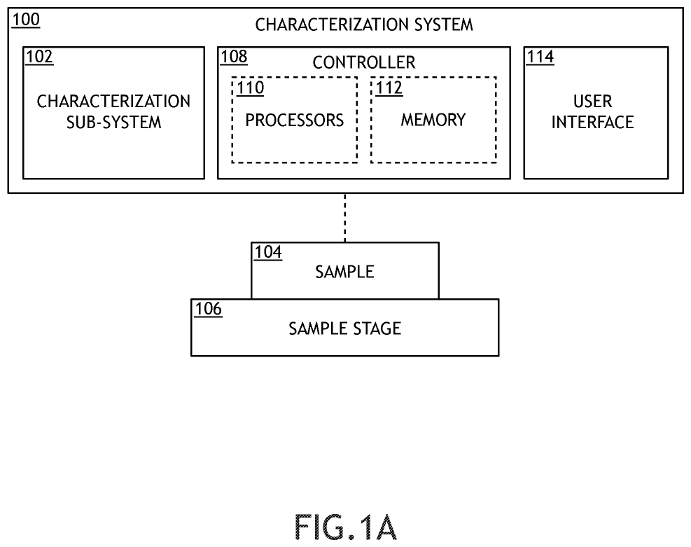

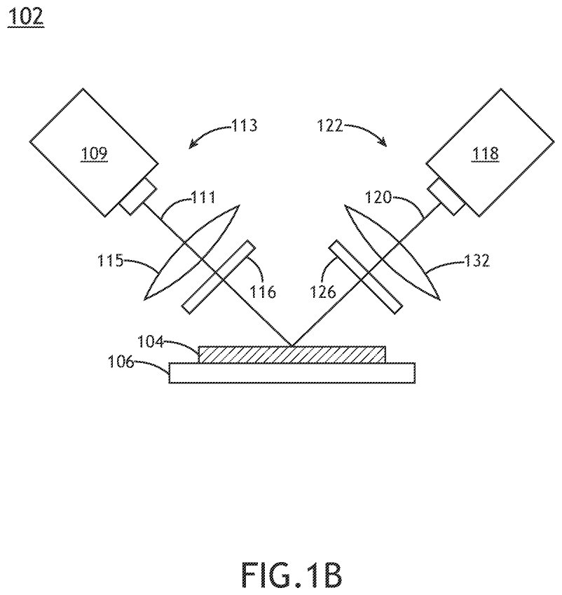

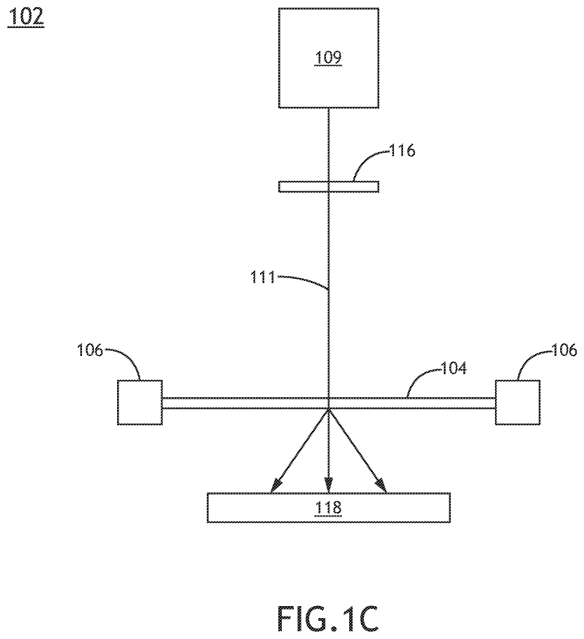

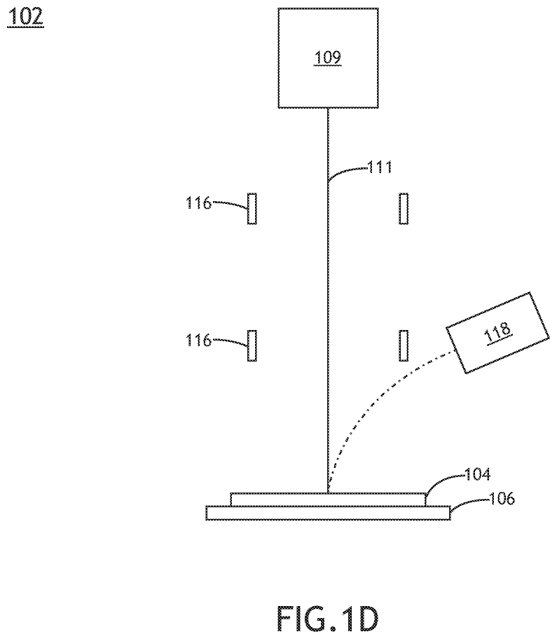

Referring now to FIGS. 1A-6, systems and methods for improving measurement performance of characterization systems are described in greater detail, in accordance with one or more embodiments of the present disclosure.

FIG. 1A is a simplified schematic block diagram of a characterization system 100, in accordance with one or more embodiments of the present disclosure.

In embodiments, the characterization system 100 includes a characterization sub-system 102 configurable according to a characterization recipe (e.g., inspection recipe, metrology recipe, or the like) to generate characterization data associated with a characterization target on a sample 104.

In embodiments, the characterization sub-system 102 includes one or more metrology sub-systems. For example, the metrology sub-system 102 may include an optical metrology sub-system configured to generate optical metrology data associated with the sample 104. By way of another example, the metrology sub-system 102 may include an x-ray metrology sub-system configured to generate x-ray metrology data associated with the sample 104. By way of another example, the metrology sub-system 102 may include a particle beam metrology sub-system configured to generate e-beam metrology data associated with the sample 104 such as, but not limited to, a scanning electron microscope (SEM) metrology sub-system, a transmission electron microscope (TEM) metrology sub-system, or the like.

In embodiments, the characterization sub-system 102 includes one or more inspection sub-systems. For example, the inspection sub-system 102 may include an optical inspection sub-system configured to generate optical inspection data associated with the sample 104. By way of another example, the inspection sub-system 102 may include a particle beam inspection sub-system configured to generate e-beam inspection data associated with the sample 104. By way of another example, the inspection sub-system 102 may include an x-ray inspection sub-system configured to generate x-ray inspection data associated with the sample 104.

In embodiments, the sample 104 is disposed on a sample stage 106. The sample stage 106 may include any device suitable for positioning and/or scanning the sample 104 within the characterization sub-system 102. For example, the sample stage 106 may include any combination of linear translation stages, rotational stages, tip/tilt stages, or the like. In this way, the sample stage 106 may align a selected target within a measurement field of view of the characterization sub-system 102 for a measurement.

The sample 104 may include a substrate formed of a semiconductor or non-semiconductor material (e.g., a wafer, or the like). For example, a semiconductor or non-semiconductor material may include, but is not limited to, monocrystalline silicon, gallium arsenide, and indium phosphide. The sample may further include a mask, a lens (e.g., a metalens), a reticle, or the like formed of a semiconductor or non-semiconductor material. The sample 104 may further include one or more layers disposed on the substrate. For example, such layers may include, but are not limited to, a resist, a dielectric material, a conductive material, and a semiconductive material. Many different types of such layers are known in the art, and the term sample as used herein is intended to encompass a sample on which all types of such layers may be formed. One or more layers formed on a sample may be patterned or unpatterned. For example, a sample may include a plurality of dies, each having repeatable patterned features. Formation and processing of such layers of material may ultimately result in completed devices. Many different types of devices may be formed on a sample, and the term sample as used herein is intended to encompass a sample on which any type of device known in the art is being fabricated.

Referring now to FIGS. 1B-1D, various configurations of the characterization sub-system 102 are described in greater detail, in accordance with one or more embodiments of the present disclosure.

In a general sense, a characterization sub-system 102 may illuminate the sample 104 with at least one illumination beam and collect at least one measurement signal from the sample 104 in response to the illumination beam. The illumination beam may include, but is not limited to, an optical beam (e.g., a light beam) at any wavelength or range of wavelengths, an x-ray beam, an electron beam, or an ion beam. In this way, the characterization sub-system 102 may operate as an optical characterization sub-system, an x-ray characterization sub-system, an electron-beam (e.g., e-beam) characterization sub-system, or an ion beam characterization sub-system.

FIG. 1B is a simplified schematic view of a characterization sub-system 102 suitable for optical measurements, in accordance with one or more embodiments of the present disclosure. For example, FIG. 1B may generally illustrate various configurations including, but not limited to, a spectroscopic ellipsometer (SE), an SE with multiple angles of illumination, an SE measuring Mueller matrix elements (e.g. using rotating compensator(s)), a single-wavelength ellipsometer, a beam profile ellipsometer (angle-resolved ellipsometer), a beam profile reflectometer (angle-resolved reflectometer), a broadband reflective spectrometer (spectroscopic reflectometer), a single-wavelength reflectometer, an angle-resolved reflectometer, an imaging system, or a scatterometer (e.g., speckle analyzer). The wavelengths for optical systems can vary from about 120 nm to 3 microns. For non-ellipsometer systems, signals collected can be polarization-resolved or unpolarized.

In embodiments, the characterization sub-system 102 includes an illumination source 109 to generate an optical illumination beam 111. The illumination beam 111 may include one or more selected wavelengths of light including, but not limited to, ultraviolet (UV) radiation, visible radiation, or infrared (IR) radiation.

The illumination source 109 may be any type of illumination source known in the art suitable for generating an optical illumination beam 111. In embodiments, the illumination source 109 includes a broadband plasma (BBP) illumination source. In this regard, the illumination beam 111 may include radiation emitted by a plasma. For example, a BBP illumination source 109 may include, but is not required to include, one or more pump sources (e.g., one or more lasers) configured to focus into the volume of a gas, causing energy to be absorbed by the gas in order to generate or sustain a plasma suitable for emitting radiation. Further, at least a portion of the plasma radiation may be utilized as the illumination beam 111.

In embodiments, the illumination source 109 may include one or more lasers. For instance, the illumination source 109 may include any laser system known in the art capable of emitting radiation in the infrared, visible, or ultraviolet portions of the electromagnetic spectrum.

The illumination source 109 may further produce an illumination beam 111 having any temporal profile. For example, the illumination source 109 may produce a continuous illumination beam 111, a pulsed illumination beam 111, or a modulated illumination beam 111. Additionally, the illumination beam 111 may be delivered from the illumination source 109 via free-space propagation or guided light (e.g., an optical fiber, a light pipe, or the like).

In embodiments, the illumination source 109 directs the illumination beam 111 to the sample 104 via an illumination pathway 113. The illumination pathway 113 may include one or more illumination pathway lenses 116 or additional optical components 115 suitable for modifying and/or conditioning the illumination beam 111. For example, the one or more optical components 115 may include, but are not limited to, one or more polarizers, one or more filters, one or more beam splitters, one or more diffusers, one or more homogenizers, one or more apodizers, or one or more beam shapers.

In embodiments, the metrology sub-system 102 includes a detector 118 configured to capture photon or particle emissions from the sample 104 (e.g., a collection signal 120) through a collection pathway 122. The collection pathway 122 may include, but is not limited to, one or more collection pathway lenses 124 for directing at least a portion of the collection signal 120 to a detector 118. For example, a detector 118 may receive collected, reflected or scattered light (e.g., via specular reflection, diffuse reflection, and the like) from the sample 104 via one or more collection pathway lenses 124. By way of another example, a detector 118 may receive one or more diffracted orders of radiation from the sample 104 (e.g., 0-order diffraction, ±1 order diffraction, ±2 order diffraction, and the like). By way of another example, a detector 118 may receive radiation generated by the sample 104 (e.g., luminescence associated with absorption of the illumination beam 111, or the like).

In some embodiments, the illumination beam 111 and the collection signal 120 may go through the same objective lens. For example, the illumination pathway 113 and the collection pathway 122 may share the same objective lens.

The detector 118 may include any type of detector known in the art suitable for measuring illumination received from the sample 104. For example, a detector 118 may include, but is not limited to, a charge-coupled device (CCD) detector, a time delay integration (TDI) detector, a photomultiplier tube (PMT), an avalanche photodiode (APD), or the like. In embodiments, a detector 118 may include a spectroscopic detector suitable for identifying wavelengths of light emanating from the sample 104.

The collection pathway 122 may further include any number of collection pathway lenses 132 or collection optical elements 126 to direct and/or modify collected illumination from the sample 104 including, but not limited to, one or more filters, one or more polarizers, one or more apodizers, or one or more beam blocks.

FIG. 1C is a simplified schematic view of the characterization sub-system 102 configured as an x-ray sub-system, in accordance with one or more embodiments of the present disclosure. The metrology sub-system 102 may include any type of x-ray sub-system known in the art suitable for providing an x-ray illumination beam 111 and capturing an associated collection signal 120, which may include, but is not limited to, x-ray emissions, optical emissions, or particle emissions. Examples of x-ray configurations include, but are not limited to, a small-angle x-ray scatterometer (SAXR), or a soft x-ray reflectometer (SXR).

In embodiments, the characterization sub-system 102 includes x-ray illumination pathway lenses 116 suitable for collimating or focusing an x-ray illumination beam 111 and collection pathway lenses (not shown) suitable for collecting, collimating, and/or focusing X-rays from the sample 104. For example, the metrology sub-system 102 may include, but is not limited to, x-ray collimating mirrors, specular x-ray optics such as grazing incidence ellipsoidal mirrors, polycapillary optics such as hollow capillary x-ray waveguides, multilayer optics, or systems, or any combination thereof. In embodiments, the metrology sub-system 102 includes an x-ray detector 118 such as, but not limited to, an x-ray monochromator (e.g., a crystal monochromator such as a Loxley-Tanner-Bowen monochromator, or the like), x-ray apertures, x-ray beam stops, or diffractive optics (e.g., such as zone plates).

FIG. 1D is a simplified schematic view of the characterization sub-system 102 configured as a particle beam metrology sub-system (e.g., an e-beam metrology sub-system), in accordance with one or more embodiments of the present disclosure.

In embodiments, the characterization sub-system 102 includes one or more particle focusing elements (e.g., illumination pathway lenses 116, collection pathway lenses 124 (not shown), or the like). For example, the one or more particle focusing elements may include, but are not limited to, a single particle focusing element or one or more particle focusing elements forming a compound system. Further, the one or more particle focusing elements may include any type of electron lenses known in the art including, but not limited to, electrostatic, magnetic, uni-potential, or double-potential lenses. It is noted herein that the description of a voltage contrast imaging inspection system as depicted in FIG. 1C and the associated descriptions above are provided solely for illustrative purposes and should not be interpreted as limiting. For example, the metrology sub-system 102 may include any excitation source known in the art suitable for generating inspection data on a sample 104. In embodiments, the metrology sub-system 102 includes two or more particle beam sources (e.g., electron beam sources or ion beam sources) for the generation of two or more particle beams. In embodiments, the metrology sub-system 102 includes one or more components (e.g., one or more electrodes) configured to apply one or more voltages to one or more locations of the sample 104. In this regard, the metrology sub-system 102 may generate voltage contrast imaging data.

In embodiments, the characterization sub-system 102 includes one or more particle detectors 118 to image or otherwise detect particles emanating from the sample 104. In embodiments, the one or more particle detectors 118 include an electron collector (e.g., a secondary electron collector, a backscattered electron detector, or the like). In embodiments, the one or more particle detectors 118 include a photon detector (e.g., a photodetector, an x-ray detector, a scintillating element coupled to a photomultiplier tube (PMT) detector, or the like) for detecting electrons and/or photons from the sample surface.

Referring now generally to FIGS. 1A-1D, various hardware configurations may be separated into discrete operational systems or integrated within a single sub-system. For example, the metrology sub-system may combine a combination of multiple hardware configurations in a single sub-system, as generally described in U.S. Pat. No. 7,933,026 which is hereby incorporated by reference in its entirety. By way of another example, multiple metrology sub-systems may be used for measurements on a single or multiple metrology targets, as generally described in U.S. Pat. No. 7,478,019, which is incorporated herein by reference in its entirety. Various hardware configurations are generally described in U.S. Pat. Nos. 5,608,526, 5,859,424, and 6,429,943, all of which are incorporated herein by reference in their entirety.

The characterization sub-system 102 may further be configured in various hardware configurations to measure various structure and/or material characteristics of one or more layers of the sample 104 including, but not limited to, overlay, tilt, critical dimensions (CDs) of one or more structures, film thicknesses, or film compositions after one or more fabrication steps.

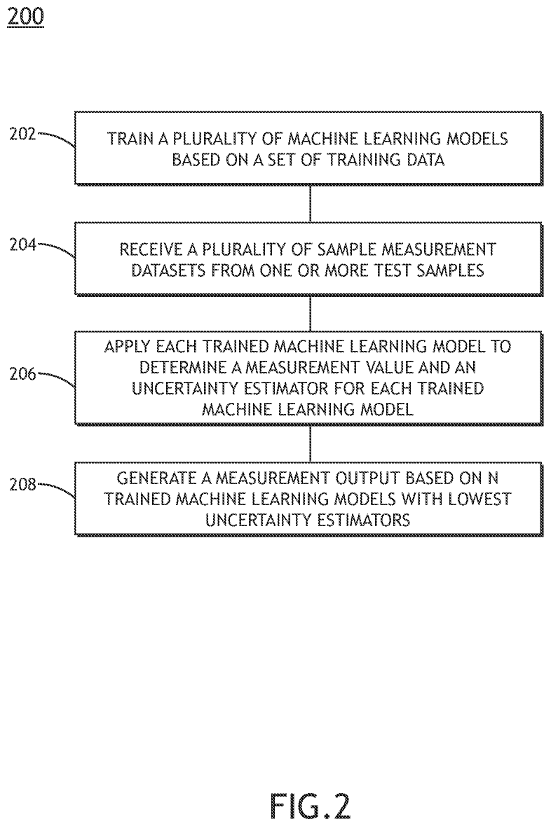

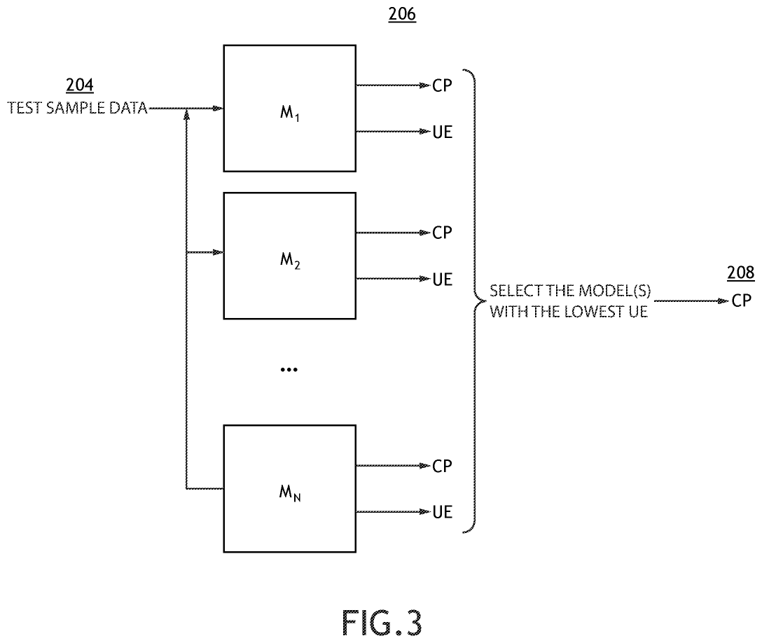

Referring now to FIGS. 2-3, various method steps for improving measurement performance for characterization systems are described in greater detail, in accordance with one or more embodiments of the present disclosure. Applicant notes that the embodiments and enabling technologies described previously herein in the context of the characterization system 100 should be interpreted to extend to the steps below. It is further noted, however, that the steps below are not limited to the architecture of the characterization system 100.

FIG. 2 is a flow diagram depicting a method 200 for improving measurement performance of a characterization system, in accordance with one or more embodiments of the present disclosure.

In a step 202, a plurality of machine learning models may be trained based on a set of training data. For the purposes of the present disclosure, the term “training data” may be regarded as data that will be used as inputs to train a machine learning model.

In embodiments, the set of training data may include empirical data obtained from one or more samples. For example, the characterization sub-system 102 may be configured to obtain empirical data from the one or more samples and provide the empirical data to the controller 108.

In embodiments, the set of training data may include simulated data obtained from one or more geometric models. For example, the controller 108 (or an external controller) may be configured to generate one or more geometric models to generate the simulated data.

The simulated data and/or empirical data may include, but is not limited to, one or more spectra, one or more images, or the like.

In the context of supervised learning, the set of training data be labeled based on known information. In this regard, the controller 108 may receive reference data associated with the set of training data. Accordingly, the set of training data (e.g., empirical data and/or simulated data) and reference data may be used as inputs to train the plurality of machine learning models. The controller 108 may be further configured to store the reference data and the plurality of trained machine learning models in memory 112.

In embodiments, the plurality of machine learning models may be at least partially different. For example, a first machine learning model of the plurality of machine learning models may be different from one or more additional machine learning models based on one of a set of hyperparameters (i.e. parameters of the machine learning model) or a dataset.

In one instance, where the machine learning models differ based on a dataset, the respective machine learning models may be trained using different datasets. In this regard, the first machine learning model may include a first dataset and the one or more additional machine learning models may include one or more additional datasets, where the one or more additional datasets of the one or more additional machine learning models are different from the first dataset of the first machine learning model.

In another instance, where the machine learning models differ based on a set of hyperparameters, the respective machine learning models may differ based on the hyperparameters of the models themselves. In this regard, the first machine learning model may include a first set of hyperparameters and the one or more additional machine learning models may include one or more additional sets of hyperparameters, where the one or more additional sets of hyperparameters of the one or more additional machine learning models are different from the first set of hyperparameters of the first machine learning model. The set of hyperparameters may include, but is not limited to, neural network layers, neurons, regularization, dropout layers, Monte Carlo dropout, Bayesian neural networks, and the like.

In embodiments, each machine learning model of the plurality of machine learning models is capable of generating an uncertainty estimator. For example, during runtime, the trained machine learning model may be applied to sample measurement data to determine a measurement value and an uncertainty estimator, as will be discussed further herein.

It is noted that the plurality machine learning models may include any type of machine learning algorithm and/or deep learning technique including, but not limited to, a deep learning regression model, an ensemble learning algorithm, an artificial neural network (ANN), a convolutional neural network (CNN), residual neural networks, and the like.

In a step 204, during runtime, a plurality of sample measurement datasets for one or more test samples may be received. For example, the controller 108 may be configured to receive the plurality of sample measurement datasets from the one or more test samples from the characterization sub-system 102. For instance, the characterization sub-system 102, in accordance with a characterization recipe, may be configured to generate one or more characterization measurements using the plurality of trained machine learning models.

In a step 206, for each received sample measurement dataset of the plurality of received sample measurement datasets, each trained machine learning model may be applied to the respective dataset to determine a measurement value and an uncertainty estimator for each trained machine learning model of the plurality of trained machine learning models. For example, as shown in FIG. 3, the controller 108 may be configured to determine a measurement value (e.g., critical parameter Cp) and an uncertainty estimator (UE) for each trained machine learning model. For instance, as shown in FIG. 3, a first machine learning model M₁ may be applied to the test sample measurement dataset to determine a first CP value and a first UE value, a second machine learning model M₂ may be applied to the test sample measurement dataset to determine a second CP value and a second UE value, and an N machine learning model MN may be applied to determine an Nth CP value and an Nth UE value.

In embodiments, the uncertainty estimator for each trained machine learning model indicates the measurement uncertainty for the respective trained machine learning model. For example, during runtime, the plurality of trained machine learning models with different hyperparameters be applied and an uncertainty estimator for respective models may be provided based on the output differences. By way of another example, during runtime, the plurality of trained machine learning models trained with various datasets may be applied and an uncertainty estimator for respective models may be provided based on the output differences.

The uncertainty estimator may include, but is not limited to, Bayesian Neural Networks, Monte Carlo Dropout, Deep ensembles, and the like.

For example, the lower the uncertainty estimator, the less uncertainty there is for the associated measurement value. In this regard, the measurement performance of the characterization is improved by selecting the N measurement values associated with the N lowest uncertainty estimator values.

In a step 208, for each received sample measurement dataset of the plurality of received sample measurement datasets, a measurement output may be generated. For example, the controller 108 may be configured to generate the measurement output based the N measurement values associated with the N lowest uncertainty estimator values of the respective N trained machine learning models.

In embodiments, N may include an integer equal to one. For example, the controller 108 may be configured to select one uncertainty estimator of one trained machine learning model, where the selected uncertainty estimator may have substantially the lowest (or smallest) value. Further, as shown in FIG. 3, the controller 108 may be configured to provide an associated measurement value of the selected trained machine learning model with the lowest uncertainty estimator as the single measurement output. For instance, as shown in FIG. 3, the controller 103 may select the trained machine learning model with the lowest UE from the plurality of machine learning models M₁-M_{N} and the associated measurement value CP may be selected as the measurement output.

In embodiments, N may include an integer equal to or greater than two. For example, the controller 108 may be configured to select two or more uncertainty estimators, where the selected two or more uncertainty estimators may be the two or more lowest (or smallest) values. Further, the controller 108 may be configured generate a measurement output by averaging the associated measurement values of the selected two or more trained machine learning models with the two or more lowest uncertainty estimators. In a non-limiting example, where N is three, the controller 108 may be configured to select three measurement values associated with the three lowest uncertainty estimators and average the selected three measurement values to generate the measurement output. In this regard, the measurement values associated with the three trained machine learning models with the three lowest uncertainty estimators may be used, such that the variability of the uncertainty estimators may be reduced. It is noted that the average value may include a per sample average, a per lot average, or based on a plurality of samples.

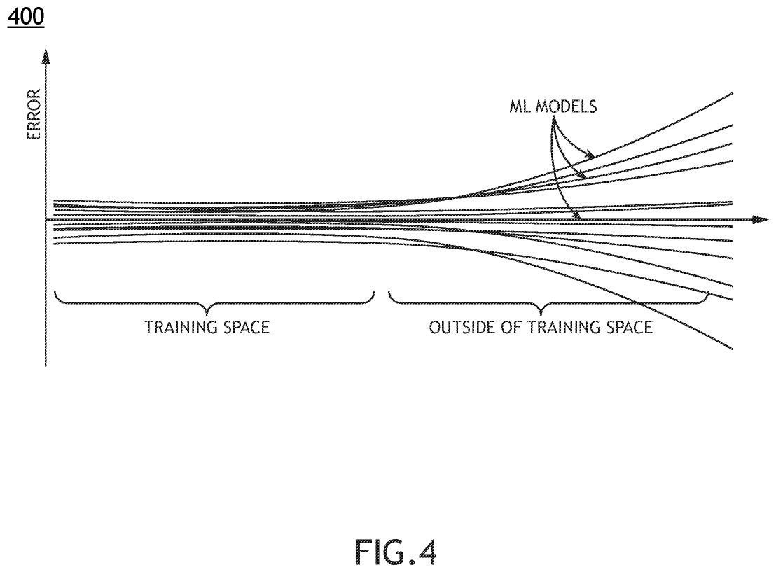

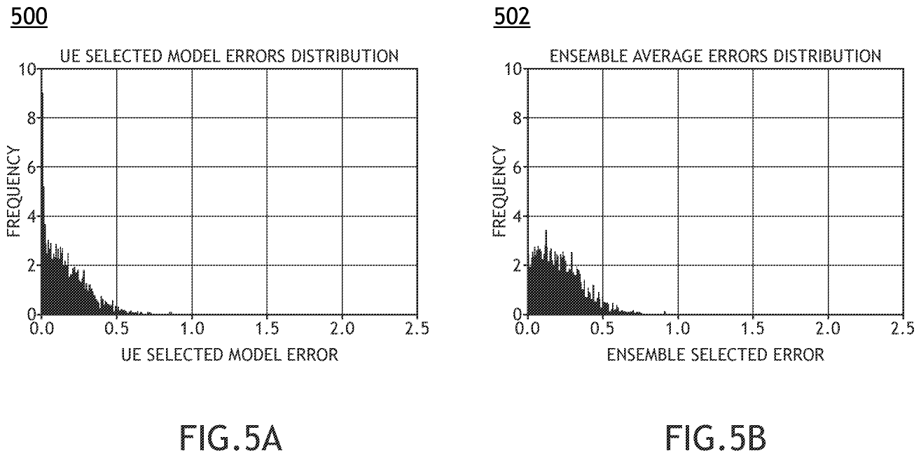

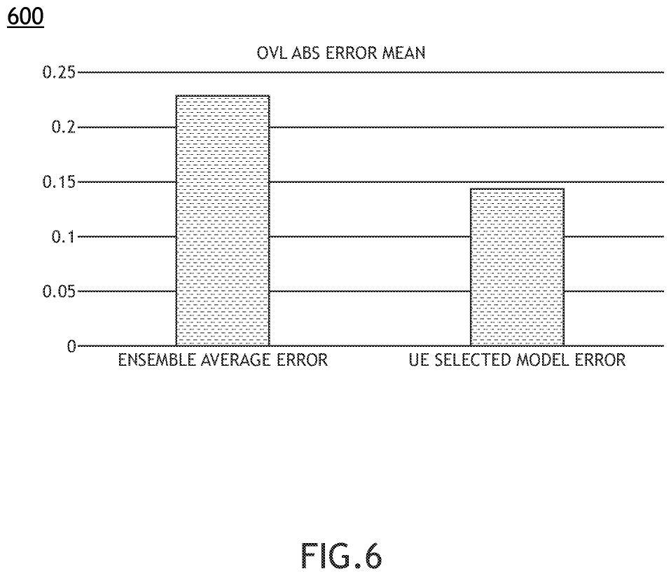

As previously discussed herein, using the uncertainty estimator(s) to select the best machine learning model for measurement makes the composite model robust in extrapolation (i.e. on samples outside of the training range). For example, as shown in the plot 400 of FIG. 4, the machine learning models may perform consistently well (i.e. with small errors) within the distribution (i.e. interpolation), but poorly out of the distribution (i.e. extrapolation). In extrapolation, the machine learning models perform differently, such that the models may overestimate or underestimate. Further, some machine learning models may extrapolate well (i.e. small errors) depending on the specific changes of the distribution data outside the training range. Selecting the best machine learning model based on the lowest uncertainty estimators reduces errors. For example, the frequency of errors when using the uncertainty estimator is reduced (as depicted in plot 500 shown in FIG. 5A) in comparison to ensemble models where uncertainty estimators are not used (as depicted in plot 502 shown in FIG. 5B). Further, as shown in FIG. 6, the absolute error mean of a system utilizing uncertainty estimators is lower than a system without uncertainty estimators.

It is noted that FIGS. 4-6 are provided merely for illustrative purposes and shall not be construed as limiting the scope of the present disclosure.

Referring again to FIG. 1A, additional components of the characterization system 100 are described in greater detail, in accordance with one or more embodiments of the present disclosure.

In embodiments, the characterization system 100 includes a controller 108 communicatively coupled to the characterization sub-system 102 and/or any components therein. In embodiments, the controller 108 includes one or more processors 110. For example, the one or more processors 110 may be configured to execute a set of program instructions maintained in a memory device 112 (or memory). The one or more processors 110 of a controller 108 may include any processing element known in the art. In this sense, the one or more processors 110 may include any microprocessor-type device configured to execute algorithms and/or instructions.

The one or more processors 110 of a controller 108 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 110 may include any device configured to execute algorithms and/or instructions (e.g., program instructions stored in memory). In embodiments, the one or more processors 110 may be embodied as a desktop computer, mainframe computer system, workstation, image computer, parallel processor, networked computer, or any other computer system configured to execute a program configured to operate or operate in conjunction with the characterization system 100, as described throughout the present disclosure. Moreover, different subsystems of the characterization system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 108 may include one or more controllers housed in a common housing or within multiple housings. In this way, any controller or combination of controllers may be separately packaged as a module suitable for integration into the characterization system 100.

The memory device 112 may include any storage medium known in the art suitable for storing program instructions executable by the associated one or more processors 110. For example, the memory device 112 may include a non-transitory memory medium. By way of another example, the memory device 112 may include, but is not limited to, a read-only memory (ROM), a random-access memory (RAM), a magnetic or optical memory device (e.g., disk), a magnetic tape, a solid-state drive and the like. It is further noted that the memory device 112 may be housed in a common controller housing with the one or more processors 110. In embodiments, the memory device 112 may be located remotely with respect to the physical location of the one or more processors 110 and the controller 108. For instance, the one or more processors 110 of the controller 108 may access a remote memory (e.g., server), accessible through a network (e.g., internet, intranet and the like).

The controller 108 may direct (e.g., through control signals) or receive data from the characterization sub-system 102 or any components therein. The controller 108 may further be configured to perform any of the various process steps described throughout the present disclosure.

In embodiments, the memory device 112 includes a data server. For example, the data server may collect data from the characterization sub-system 102 or other external sub-systems associated with the characterization targets at any processing step or steps (e.g., ADI steps, AEI steps, ACI steps, or the like). The data server may also store training data associated with training or otherwise generating a characterization recipe. The controller 108 may then utilize any such data to create, update, retrain, or modify characterization recipes used to generate characterization measurements using characterization data from the device targets.

In embodiments, the characterization system 100 includes a user interface 114 communicatively coupled to the controller 108. In embodiments, the user interface 114 may include, but is not limited to, one or more desktops, laptops, tablets, and the like. In embodiments, the user interface 114 includes a display used to display data of the characterization system 100 to a user. The display of the user interface 114 may include any display known in the art. For example, the display may include, but is not limited to, a liquid crystal display (LCD), an organic light-emitting diode (OLED) based display, or a CRT display. Those skilled in the art should recognize that any display device capable of integration with a user interface 114 is suitable for implementation in the present disclosure. In embodiments, a user may input selections and/or instructions responsive to data displayed to the user via a user input device of the user interface 114.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random-access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A characterization system, the characterization system comprising:
one or more controllers including one or more processors configured to execute a set of program instructions stored in memory, the set of program instructions configured to cause the one or more processors to:
train a plurality of machine learning models based on a set of training data, the set of training data including empirical data labeled based on
known information or simulated data labeled based on known information, each machine learning model of the plurality of machine learning
models capable of generating an uncertainty estimator,
a first machine learning model of the plurality of machine learning models being different from one or more additional machine learning models based on at least one of a set of hyperparameters or a dataset;
receive a plurality of sample measurement datasets from one or more test samples;
for each of the plurality of sample measurement datasets:
apply each trained machine learning model to determine a measurement value and the uncertainty estimator for each trained machine learning model; and
generate a measurement output based on N trained machine learning models with the lowest uncertainty estimators, wherein the N trained machine learning models are a sub-set of the plurality of trained machine learning models.

2. The system of claim 1, wherein N is an integer equal to one.

3. The system of claim 2, wherein the generate a measurement output based on N trained machine learning models with the lowest uncertainty estimator, wherein the N trained machine learning models are a sub-set of the plurality of trained machine learning models comprises:
selecting one trained machine learning model with the lowest uncertainty estimator from the plurality of trained machine learning models; and
provide an associated measurement value of the selected trained machine learning model with the lowest uncertainty estimator as the measurement output.

4. The system of claim 1, wherein N is an integer equal to two or greater than two.

5. The system of claim 4, wherein the generate a measurement output based on N trained machine learning models with the lowest uncertainty estimator, wherein the N trained machine learning models are a sub-set of the plurality of trained machine learning models comprises:
select two or more trained machine learning models with the lowest uncertainty estimators from the plurality of trained machine learning models; and
generate the measurement output by averaging the associated measurement values of the selected two or more trained machine learning models with the lowest uncertainty estimators.

6. The system of claim 1, wherein the first machine learning model includes a first set of hyperparameters and the one or more additional machine learning models include one or more additional sets of hyperparameters, where the one or more additional sets of hyperparameters of the one or more additional machine learning models are different from the first set of hyperparameters of the first machine learning model.

7. The system of claim 1, where the first machine learning model includes a first dataset and the one or more additional machine learning models include one or more additional datasets, where the one or more additional datasets of the one or more additional machine learning models are different from the first dataset of the first machine learning model.

8. The system of claim 1, wherein the set of hyperparameters comprise at least one of:
neural network layers, neurons, regularization, dropout layers, Monte Carlo dropout, or Bayesian neural networks.

9. The system of claim 1, wherein the plurality of machine learning models comprise at least one of:
a deep learning regression model, an ensemble learning algorithm, an artificial neural network, a convolutional neural network, or a residual neural network.

10. The system of claim 1, wherein the uncertainty estimator includes at least one of:
Bayesian Neural Networks, Monte Carlo Dropout, or Deep ensembles.

11. The system of claim 1, further comprising:
a metrology sub-system communicatively coupled to the one or more controllers.

12. The system of claim 11, wherein the metrology sub-system comprises at least one of:
a spectroscopic ellipsometer, a reflectometer, a small angle x-ray scatterometer, a scanning electron microscope, a transmission electron microscope, or an optical sub-system.

13. The system of claim 1, wherein the sample comprises a substrate.

14. The system of claim 13, wherein the substrate comprises a wafer.

15. A characterization system, the characterization system comprising:
a characterization sub-system; and
one or more controllers communicatively coupled to the characterization sub-system, the one or more controllers including one or more processors configured to execute a set of program instructions stored in memory, the set of program instructions configured to cause the one or more processors to:
train a plurality of machine learning models based on a set of training data,
the set of training data including empirical data acquired from a sample and labeled based on known information or simulated data acquired from a geometric model of the sample and labeled based on known information,
each machine learning model of the plurality of machine learning models capable of generating an uncertainty estimator,
a first machine learning model of the plurality of machine learning models being different from one or more additional machine learning models based on at least one of a set of hyperparameters or a dataset;
receive a plurality of sample measurement datasets from one or more test samples;
for each of the plurality of sample measurement datasets:
apply each trained machine learning model determine a measurement value and the uncertainty estimator for each trained machine learning model; and
generate a measurement output based on N trained machine learning models with the lowest uncertainty estimators, wherein the N trained machine learning models are a sub-set of the plurality of trained machine learning models.

16. The system of claim 15, wherein N is an integer equal to one.

17. The system of claim 16, wherein the generate a measurement output based on N trained machine learning models with the lowest uncertainty estimator, wherein the N trained machine learning models are a sub-set of the plurality of trained machine learning models comprises:
selecting one trained machine learning model with the lowest uncertainty estimator from the plurality of trained machine learning models; and
provide an associated measurement value of the selected trained machine learning model with the lowest uncertainty estimator as the measurement output.

18. The system of claim 15, wherein N is an integer equal to two or greater than two.

19. The system of claim 18, wherein the generate a measurement output based on N trained machine learning models with the lowest uncertainty estimator, wherein the N trained machine learning models are a sub-set of the plurality of trained machine learning models comprises:
select two or more trained machine learning models with the lowest uncertainty estimators from the plurality of trained machine learning models; and
generate the measurement output by averaging the associated measurement values of the selected two or more trained machine learning models with the lowest uncertainty estimators.

20. The system of claim 15, wherein the first machine learning model includes a first set of hyperparameters and the one or more additional machine learning models include one or more additional sets of hyperparameters, where the one or more additional sets of hyperparameters of the one or more additional machine learning models are different from the first set of hyperparameters of the first machine learning model.

21. The system of claim 15, where the first machine learning model includes a first dataset and the one or more additional machine learning models include one or more additional datasets, where the one or more additional datasets of the one or more additional machine learning models are different from the first dataset of the first machine learning model.

22. The system of claim 15, wherein the set of hyperparameters comprise at least one of:
neural network layers, neurons, regularization, dropout layers, Monte Carlo dropout, or Bayesian neural networks.

23. The system of claim 15, wherein the plurality of machine learning models comprise at least one of:
a deep learning regression model, an ensemble learning algorithm, an artificial neural network, a convolutional neural network, or a residual neural network.

24. The system of claim 15, wherein the uncertainty estimator includes at least one of:
Bayesian Neural Networks, Monte Carlo Dropout, or Deep ensembles.

25. The system of claim 15, wherein the characterization sub-system comprises a metrology sub-system.

26. The system of claim 25, wherein the metrology sub-system comprises at least one of:
a spectroscopic ellipsometer, a reflectometer, a small angle x-ray scatterometer, a scanning electron microscope, a transmission electron microscope, or an optical metrology sub-system.

27. A method, the method comprising:
training a plurality of machine learning models based on a set of training data,
the set of training data including empirical data labeled based on known information or simulated data labeled based on known information,
each machine learning model of the plurality of machine learning models capable of generating an uncertainty estimator,
a first machine learning model of the plurality of machine learning models being different from one or more additional machine learning models based on at least one of a set of hyperparameters or a dataset;
receiving a plurality of sample measurement datasets from one or more test samples;
for each of the plurality of sample measurement datasets:
applying each trained machine learning model to determine a measurement value and the uncertainty estimator for each trained machine learning model; and
generating a measurement output based on N trained machine learning models with the lowest uncertainty estimators, wherein the N trained machine learning models are a sub-set of the plurality of trained machine learning models.
